(19) United States
(12) Patent Application Publication
(10) Pub. No.: US 2007/0089163 A1
(43) Pub. Date: Apr. 19, 2007

(54) System and method for controlling security of a remote network power device

(75) Inventor: Guy Simon Denton, Raleigh, NC (US)

Correspondence Address: SILVY ANNA MURPHY, 100 TURNBERRY LANE, CARY, NC, 27511, US

(73) Assignee: International Business Machines Corporation, Armonk, NY (US)

(21) Appl. No.: 11/252,945

(22) Filed: Oct. 18, 2005

(51) Int. Cl. H04L 9/32

(52) U.S. Cl. 726/2

(57) ABSTRACT

A system and method for controlling security of a remote network power device powering a remote network device are disclosed. The system includes a remote network power supply device having a secure standard implemented thereon and having a power-supply-identity, a remote unattended network device powered from the power supply device, a portal having a secure connection for controlling the power supply device, and a power addressable protocol based on the secure standard and running on the portal for receiving and sending one or more secure communications over the secure connection in response to a directive issued by an authorized client for controlling the power supply device powering the remote unattended network device. The portal uses the power-supply-identity of the power supply device to authenticate the power supply device. Preferably, the secure standard is an IEEE 802.1x standard and, preferably, the power addressable protocol is based on the IEEE 802.1x standard.

### FIELD OF THE INVENTION

The present invention relates generally to a system and method for controlling security of remote unattended devices in a computing network environment and, in particular, the invention relates to a system and method for controlling security of a remote network power supply device that powers up a remote unattended network device, more particularly, a system and method for controlling security of a wireless power supply device that powers up a remote unattended network device.

### BACKGROUND OF THE INVENTION

In computer networks, especially in a hybrid computer network or system that includes both wired and wireless devices that are connected together, the issue of controlling access and controlling security is of critical importance. Given the widespread use of wireless clients and/or devices in computer networks, it is becoming necessary to not only authenticate a remote user or client that wants access to a particular network, but to ensure that the remote user or client is in fact authorized to access that particular network, and hence, the resources accessed through the network. Further, it is important that any data transmitted over these networks is transmitted or communicated in a secure manner, including data pertaining to any authentication information. As such, there is a need for providing security measures for securing access to wireless networks. Further, there is a need for providing information security services taking into account the dynamic nature of wireless environments, and for preventing access in which the user authentication fails or where the user's access privileges are limited or non-existent. Moreover, there is a need for controlling security on devices within a network that can control or can be used to access other devices in the network more effectively and efficiently, while managing costs of providing security. Furthermore, there is a need for providing economical ways to provide security on such systems.

### SUMMARY OF THE INVENTION

In one aspect of the invention, there is provided a system for controlling security of a remote network power supply device powering a remote unattended network device. The system comprises a remote network power supply device having a secure standard implemented thereon and having a power-supply-identity, a remote unattended network device powered from the remote network power supply device, a portal having a secure connection for controlling the remote network power supply device, and a power addressable protocol based on the secure standard and running on the portal for receiving and sending one or more secure communications over the secure connection in response to a directive issued by an authorized client for controlling the remote network power supply device powering the remote unattended network device. In one embodiment, the system further comprises an authentication server that employs the secure standard and is securely linked to the portal for validating the remote network power supply device. Preferably, the secure standard is an IEEE 802.1x standard, and the power addressable protocol is based on the IEEE 802.1x standard. The portal uses the power-supply-identity of the remote network power supply device to authenticate the remote network power supply device. Preferably, the power-supply-identity comprises either a unique serial number of the remote network power supply device, a secret or pre-shared key based on a unique serial number of the remote network power supply device, and an IEEE 802.1x certificate based on a unique serial number of the remote network power supply device. More preferably, the portal uses an encryption algorithm based on the secure standard to encrypt the power-supply-identity for authenticating the remote network power supply device. Further, the power addressable protocol running on the portal uses an encryption algorithm based on the secure standard to encrypt the directive issued by the authorized client for transmitting the encrypted directive to the remote network power supply device. Further, preferably, the portal authenticates the authorized client using an authentication method that is supported by the IEEE 802.1x standard. Preferably, the remote unattended network device and the remote network power supply device are each registered with the portal and the portal keeps a log of all requests to access the system via the remote network power supply device, as well as the outcome or result of each request to access the portal. In one embodiment, the remote network power supply device is a wireless power supply device and the system further comprises a wireless access point having the secure standard implemented thereon and linked to the portal for securely connecting the wireless power supply device to the portal.

In yet another embodiment, the invention provides a method of providing an information security service to a customer. The method comprises embedding a secure standard in a wireless power supply device powering a remote unattended network device, providing a portal having a secure connection for controlling the wireless power supply device, implementing the secure standard in a wireless access point that links the wireless power supply device to the portal, registering with the portal each of the wireless power supply device, the remote unattended network device and the wireless access point, authenticating via the portal the wireless power supply device and the wireless access point, and executing on the portal a power addressable protocol based on the secure standard for communicating one or more secure communications over the secure connection in response to a directive issued by an authorized client for controlling the wireless power supply device powering the remote unattended network device. Further, the method comprises keeping a log of all clients that request access to the portal. The authenticating step further comprises using a power-supply-identity of the wireless power supply device for authenticating the wireless power supply device, and using an encryption algorithm based on the secure standard to encrypt the power-supply-identity for authenticating the wireless power supply device. The executing step further comprises the power addressable protocol using an encryption algorithm to encrypt the directive issued by the authorized client and transmitting the encrypted directive to the wireless power supply device. The registering step further comprises assigning a role-group to each of the remote unattended network devices, the wireless power supply device, and the client such that the portal is able to validate authentication and authorization of the client in relation to the wireless power supply device and the remote unattended network devices before allowing any access to control the wireless power supply device powering the remote unattended network devices. Preferably, the secure standard is an IEEE 802.1x standard and, preferably, the power addressable protocol is based on the IEEE 802.1x standard.

In yet another embodiment, the invention provides a programmable media containing programmable software for controlling security of a remote network power device powering a remote unattended network device. The programmable software comprises registering the remote unattended network device and the remote network power supply device with a portal having a secure connection, authenticating the power supply device using a power-supply-identity of the power supply device having a secure standard embedded thereon, and executing a power addressable protocol on the portal for transmitting one or more secure communications over the secure connection in response to a directive issued by an authorized client for controlling the power supply device powering the remote unattended network device. The programmable software further comprises validating the power-supply-identity via an authentication server having the secure standard and securely linked to the portal. Further, the programmable software comprises keeping a log of all clients that request access to the portal. Preferably, the secure standard is an IEEE 802.1x standard and, preferably, the power addressable protocol is based on the IEEE 802.1x standard. Preferably, the power-supply-identity is either a unique serial number of the power supply device, a secret or pre-shared key based on a unique serial number of the power supply device, or an IEEE 802.1x certificate based on a unique serial number of the power supply device. Preferably, the portal uses the power-supply-identity of the power supply device to authenticate the power supply device, and more particularly, the power addressable protocol running on the portal uses an encryption algorithm based on the secure standard to encrypt the power-supply-identity of the power supply device. Further, the power addressable protocol uses an encryption algorithm to encrypt the directive issued by the authorized client and transmits the encrypted directive to the power supply device. In one embodiment, the power supply device is a wireless power supply device and the programmable software further comprises a wireless access point having the secure standard implemented thereon and linked to the portal for securely connecting the wireless power supply device to the portal.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 represents a system for controlling security of a remote network power device that powers one or more remote unattended network devices, with the use of an authentication server, in accordance with an embodiment of the present invention.

FIG. 2 represents a system for controlling security of a remote network power device that powers one or more remote unattended network devices, with the use of an authentication server, in accordance with an embodiment of the present invention.

FIG. 3 represents a system for controlling security of a remote network power device that powers one or more remote unattended network devices, without the use of an authentication server, in accordance with an embodiment of the present invention.

FIG. 4 is a flowchart depicting a method of authenticating a wireless power supply device on a wireless network, in accordance with an embodiment of the present invention.

FIGS. 5 and 7 is a schematic flowchart diagram illustrating a method of controlling security of a remote network power device using an authentication server, in accordance with an embodiment of the present invention.

FIGS. 6 and 7 is a schematic flowchart diagram illustrating a method of controlling security of a remote network power device without using an authentication server, in accordance with an embodiment of the present invention.

### BEST MODE FOR CARRYING OUT THE INVENTION

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Reference will now be made in detail to the preferred embodiments of the invention.

As used herein, the term “controlling security” is intended to include the tasks of controlling access, monitoring, access, managing access, restricting access, handling access, managing security, monitoring security, restricting security, directing security, handling security, checking security, prohibiting unauthorized access to a remote unattended network device, such as, a remote server or a remote terminal device, and in particular, a remote power supply device that powers up a remote unattended network device in a system, such that, access to the system can be securely controlled. Also, as used herein the term “remote unattended network device” is intended to refer to any computing device, such as, a computer or a server that is located at a distance and not easily monitored, as well as is intended to refer to a server or a computer that is located remotely on an insecure network or on a wireless network, where security is of concern. Further, the term “remote network power device” or “remote network power supply device” is intended to refer to a power supply device that is either wireless or wired and is located remotely from a user or client and powers one or more devices on a network. Furthermore, the term “wireless power supply device” is intended to refer to a power supply device that communicates wirelessly over a communications link in a network, that is, the wireless power supply device uses radio frequency (RF) rather than wires to transmit and receive data over the air, but conducts electrical power to a device via a power cable or power line. Moreover, the term “wired power supply device” as used herein is intended to refer to a power supply device unit that supplies electrical power to a computer or server via a power cable or power line for powering the remote computer or server. More generally, the term “power supply device” or “power device” is intended to refer to either a wired or a wireless power supply device that includes a power strip with multiple sockets for plugging in multiple devices as well as a power supply unit that supplies electrical power to a device or a group of devices. Further, as used herein the term “secure standard” refers to the IEEE 802.1x standard which provides a port-based framework for authenticating and securing both wireless and wired networks. The IEEE 802.1x standard supports many different authentication mechanisms and as such can be used with any one of several authentication algorithms supported by the IEEE 802.1x standard, such as LEAP, PEAP, SecureID, Kerberos, Radius, LDAP (Lightweight Directory Access Protocol), SSL (Secure Sockets Layer) and the like. Also, as used herein the term “authentication” refers to the means by which a device or a client is verified to be the device or the client, respectively. Further, the term “authorization” refers to the process of giving a client or user access to the system or a device in the system, for instance, the power supply device. As used herein, the term “authorized client” or “client authorized to control” is used to refer to a client that has been granted access, in that the client has been authenticated and the authorization of the client has been confirmed by the portal. Similarly, the term “power-supply-identity” or “PADDP identity” refers to any one of the following: a unique serial number of the power supply device itself, a secret or pre-shared key based on the unique serial number of the power supply device, or an IEEE 802.1x certificate based on the unique serial number of the power supply device. The term “portal” or “portal server” refers to a web portal, or a centralized server that provides a single web interface for accessing applications, business processes, information, resources, services and solutions.

In one aspect of the invention, there is provided a system for controlling security of a remote network power supply device that powers a remote unattended network device, preferably, a remote unattended network computer, more preferably, a remote unattended network server. The system comprises a remote network power supply device, preferably, a wireless power supply device having a secure standard or secure protocol implemented thereon and having a power-supply-identity. Preferably, the remote network power supply device has embedded thereon a chip that contains the secure standard. Further, the system comprises a remote unattended network device that is powered from the remote network power supply device, a portal or portal server having a secure connection for controlling the remote network power supply device, and a power addressable protocol based on the secure standard and running on the portal for receiving and sending one or more secure communications over the secure connection in response to a directive issued by an authorized client for controlling the remote network power supply device powering the remote unattended network device. Preferably, the secure standard is an IEEE 802.1x standard and the power addressable protocol is based on the IEEE 802.1x standard. Preferably, the power-supply-identity (also, referred to as the PADDP identity) is either a unique serial number of the power supply device itself or a secret or pre-shared key based on the unique serial number of the power supply device, or an IEEE 802.1x certificate based on the unique serial number of the power supply device. In a preferred embodiment, the portal is configured to perform the authentication of the power supply device, that is, the portal stores all the information necessary to authenticate the power supply device. In particular, the IEEE 802.1x based power addressable protocol running on the portal uses an encryption algorithm supported by the IEEE 802.1x standard to encrypt the power-supply-identity of the power supply device when authenticating the power supply device. Preferably, the power supply device is authenticated by the portal using the power addressable protocol, such that any IEEE 802.1x PADDP data packet containing the power-supply-identity is encrypted, preferably, using an Advanced Encryption Standard (AES) based encryption and is securely exchanged using the power addressable protocol between the power supply device and the portal. Furthermore, the power addressable protocol uses an encryption algorithm, such as AES to encrypt the directive issued by the client or user, that is, after the client has been authenticated and has been confirmed to be authorized to access the power supply device, and securely transmits the encrypted directive to the power supply device. More preferably, the portal logs each access request from a client or user to access the system and preferably the portal logs the result or outcome of the request transaction, including whether the access was granted or denied. In a preferred embodiment, the remote network power supply device, the portal, and the remote unattended network device are all on the same network.

In another preferred embodiment, the system further comprises an authentication server that is linked via a secure communications channel to the portal and employs the secure standard, preferably, the IEEE 802.1x standard for authenticating and/or validating the power supply device. Preferably, the authentication server is on the same network as the portal. In particular, the portal passes or conveys the authentication data or information relating to the remote network power supply device in an encrypted format to the authentication server. Preferably, the portal uses an AES mechanism within the power addressable protocol to encrypt the authentication information, namely, the power-supply-identity of the power supply device received from the power supply device and uses the power addressable protocol to transmit or communicate the information to the authentication server. The authentication server validates the information based on authentication data or information, such as, usernames and passwords or identities that are stored in a local database or has access to an external database containing the authentication data or information. The authentication server validates the power supply identity and sends an authentication success or authentication failure message to the portal. If the portal receives an authentication success message, the portal then determines the client authorization based on the client authentication. Further, the client accesses the portal via a front-end application, preferably, a web-based application that uses secure protocols for authenticating the client. Preferably, the web-based application on the portal authenticates the client using an authentication method that is supported by the IEEE 802.1x standard, preferably, SSH, however, other authentication methods such as, EAP, LEAP, PEAP, SecureID, Kerberos, Radius, LDAP, SSL, etc. can be used to authenticate the client. The remote network power supply device that powers the remote unattended network device can be a wireless power supply device that employs a wireless communications link or a wired power supply device that employs a wired communications line. Further, the network that the remote network power supply device, the remote unattended network device, the portal and the authentication server reside is either a wireless network or a wired network or a combination of the two. More preferably, the wireless network is a wireless LAN (Local Area Network) and the wired network is either an Ethernet based LAN or a Token-Ring LAN. Moreover, the network can also be a wired or wireless WAN (Wide Area Network). Preferably, the remote unattended network device and the power supply device are each registered with the portal, which runs the power addressable protocol to securely send and receive data packets containing the registration information. In an embodiment where the power supply device is a wireless power supply device, the system further comprises a wireless access point having the secure standard implemented thereon and being securely linked to the portal for providing a secure connection between the wireless power supply device and the portal, such that the one or more secure communications can be exchanged between the portal and the power supply device.

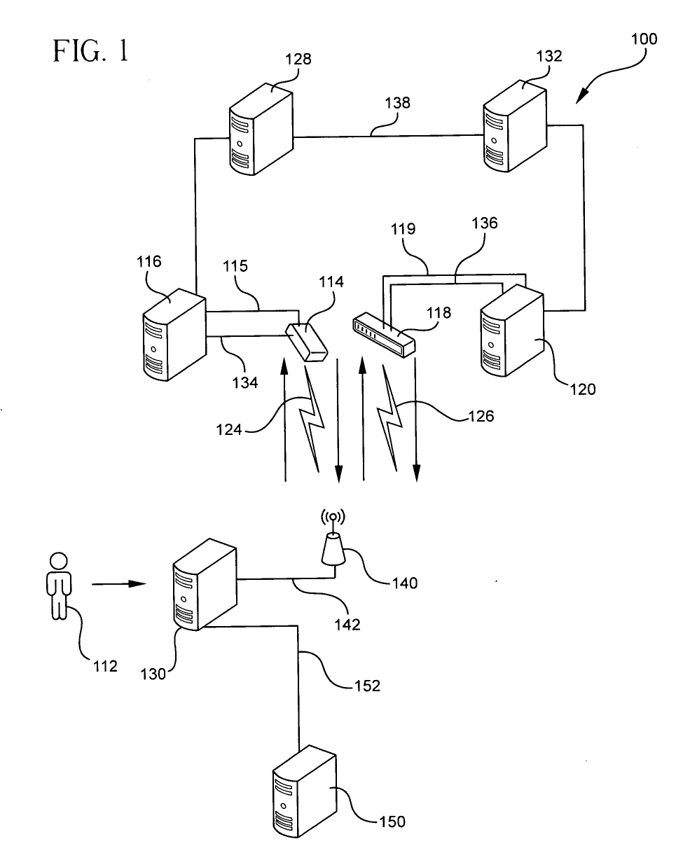

Reference is now made to FIGS. 1-3, which illustrate separate embodiments of a system for controlling security of a remote power supply device that powers one or more unattended network devices. Turning to FIG. 1, FIG. 1 illustrates a system 100 for controlling a remote network power supply device that powers one or more remote unattended network devices, in accordance with an embodiment of the invention. In particular, FIG. 1 represents a system where there are more than one remote network power supply devices that power separate network devices, such as, servers. Turning to FIG. 1, numerals 116 and 120, each represent either computers on a network, preferably, servers on a network that are powered by respective power supplies 114 and 118. As shown in FIG. 1, the remote network power supply device 114 is a single power unit that powers a single device, such as, one computer or server, etc., and as shown in FIG. 1 powers the server 116. Further, the power supply device 118 represents a power supply device strip that is capable of powering a plurality of devices, such as, one or more computer terminals, one or more servers (file servers, print servers, etc.) but is shown in FIG. 1 to be powering only the server 120. Further, the server 120 is part of a wired network that comprises servers 128, 132 and 116, wherein each of the servers is connected via a wired communications line 138, as shown in FIG. 1. Further, as shown, the power supply device 114 powers the server 116 via a power cable 115, whereas, the power supply device 114 communicates with the server 116 via wired communications line 134. Similarly, the power supply device 118 powers the server 120 via power cable 119, whereas, the power supply device 118 communicates with the server 120 via wired communications line 136. Moreover, the power supply devices 114 and 118 communicate wirelessly with the wireless access point 140. In particular, each of the power supply devices 114 and 118 communicate wireless via a wireless communications link, as shown by the symbols represented by numerals 124 and 126, respectively. The wireless access point 140 is linked to the portal 130 and, in particular, the wireless access point 140 communicates with the portal 130 via wired communications line 142, as shown in FIG. 1. Furthermore, the portal 130 is linked to an authentication server 150 via a wired communications line 152. Further, FIG. 1 shows a client or user 112 accessing the system 100 via the portal 130.

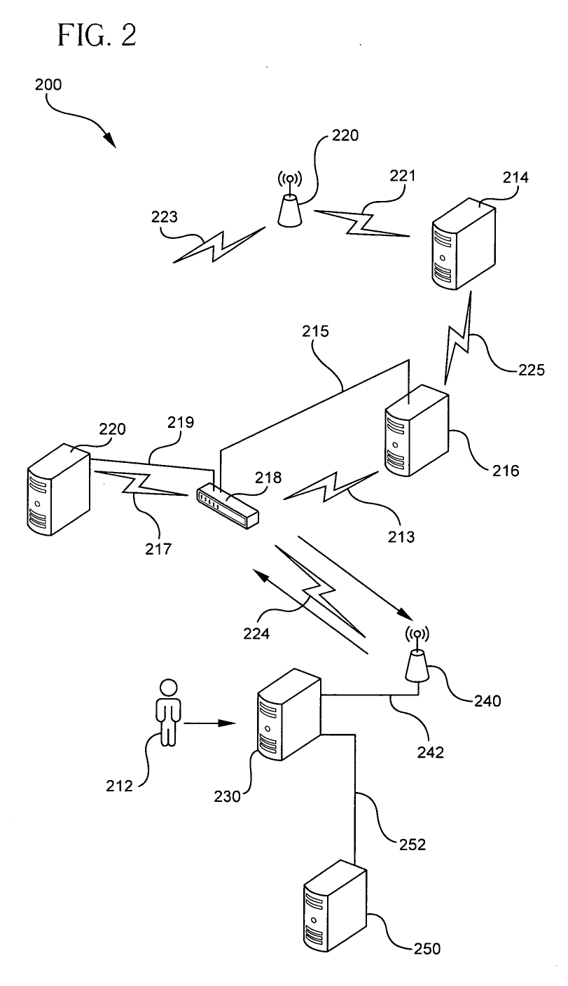

Turning to FIG. 2, FIG. 2 illustrates another embodiment of a system 200 for controlling a remote network power supply device that powers one or more network devices, in accordance with an embodiment of the invention. Turning to FIG. 2, numeral 216 and 220 are network devices, in this example, servers that are powered by a remote network power supply device 218. As shown in FIG. 2, the power supply device 218 represents a power supply device strip that powers a plurality of devices, in particular, the servers 216 and 220. The power supply device 218 powers the server 220 via the power cable 219, whereas, the power supply device 218 communicates with the server 220 via a wireless communications link 217. Similarly, the power supply device 218 powers the server 216 via the power cable 215, whereas, the power supply device 218 communicates with the server 216 via a wireless communications link 213. As shown in FIG. 2, servers 216 and 220 are both part of a wireless network made up of an additional server 214 and a wireless access point 220. Each of the servers 214, 216, and 220 and the wireless access point 220 communicate wirelessly as shown by the wireless communications links represented by 221, 223 and 225. Moreover, the power supply device 218 communicates wirelessly with a wireless access point 240, which is linked at the other end to the portal 230. In particular, the power supply device 218 communicates wirelessly via a wireless communications link, shown by the symbol represented by numeral 224. Further, the wireless access point 240 communicates with the portal 230 via wired communications line 242, as shown in FIG. 2. Furthermore, the portal 230 is linked to an authentication server 250 via a wired communications line 252. Also, FIG. 2 shows a client or user 212 accessing the system 200 via portal 230.

When setting up a system for controlling security, the system is set up, such that, all remote unattended network devices, such as, servers or computers powered by a power supply device are registered with a portal, including the power supply device itself. Preferably, when each remote server or computer powered by the power supply device is registered, the remote server or computer is assigned a role-group, that is, the remote server or computer is associated with a group and/or role that corresponds to a function or business purpose of the server or computer. Similarly, when a power supply device is registered, a role-group (role and/or group) is assigned to the power supply device corresponding to the functional role of the server or the group that the server that is being powered by that power supply device belongs to. For instance, a server that manages financial data or information may be assigned the role of a financial server. As such, the power supply device that powers up the financial server may be assigned a role that may require the power supply device to take on the role of a financial server administrator in preserving sensitive information on the financial server. Further, the registration process provides the portal with information as to who is allowed to access a particular power supply device in the system as well as what the user is allowed to do, that is, any specific authorization or rights the user has been given with respect to controlling that specific power supply device. Preferably, the power addressable protocol is used by the portal to register all the remote unattended network devices as well as the power supply device, such that the portal is able to communicate data in a secure manner. Accordingly, when the system is set up, the power supply device is registered and authenticated so that the portal does not have to authenticate the power supply device each time a client wants to access the power supply device. Preferably, the portal is a centralized server that can be accessed by a client via a front end application, preferably, a web-based application that resides on the portal for accessing the power supply device that powers up one or more remote unattended network device, such as, a server or computer that is powered by the power supply device in the system. Preferably, the portal is a portal server that is commercially available, such as, the WebSphere® portal that is commercially available from International Business Machines (IBM).

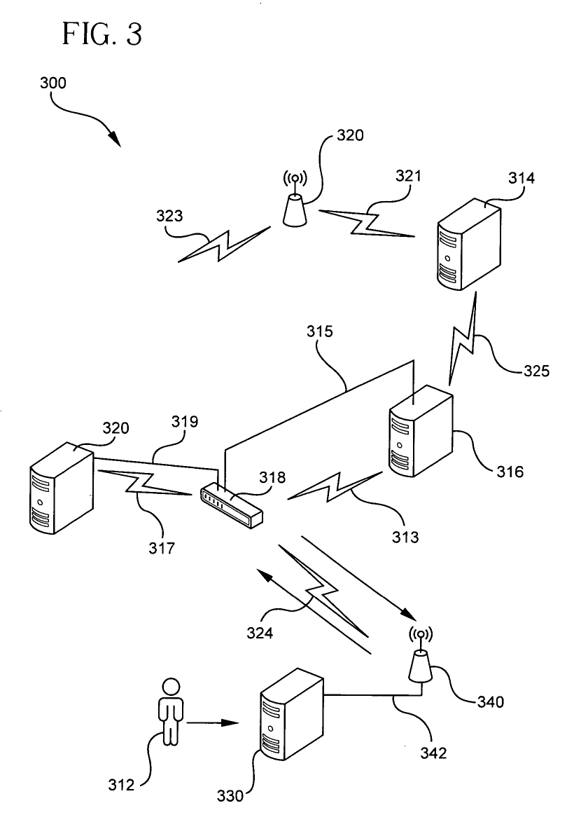

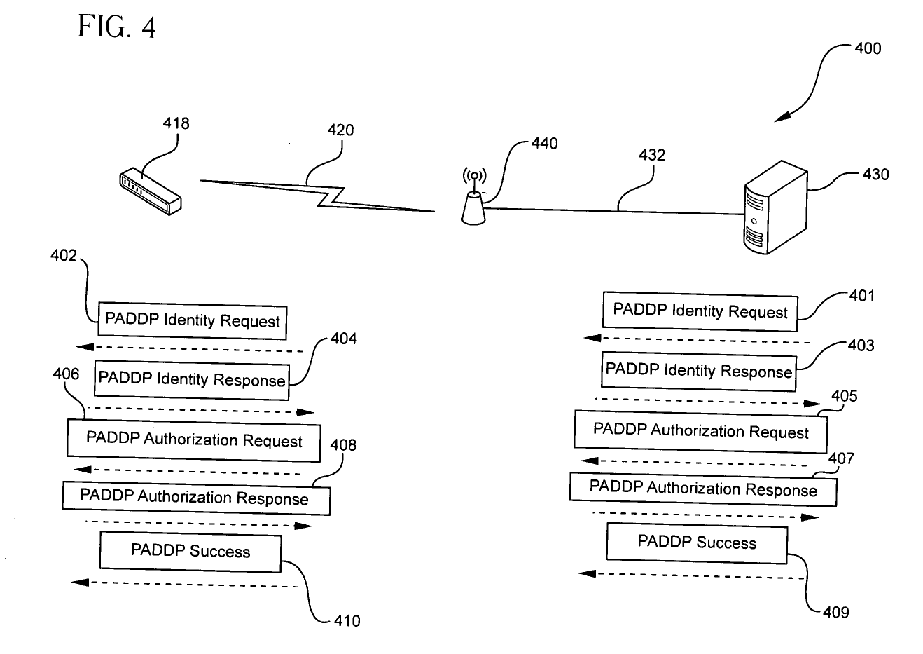

Referring to FIG. 3, reference numeral 300 shows an embodiment of a system for controlling security of a remote network power device without an authentication server. In particular, referring to FIG. 3, the wireless remote network power supply device 318 has imbedded thereon the IEEE 802.1x standard, preferably, the IEEE 802.1x standard is on a chip that is embedded within the power supply device 318. Further, the server 316 and server 320 are both powered by the wireless power supply device 318, and as such, both servers 316 and 320 and the power supply device 318 are registered with the portal 330 during the initial setup of the system 300. In a preferred embodiment, the portal 330 has a secure connection in that the portal is linked to the access point 340 via a wired communications line 342. Further, the portal 330 has implemented thereon an IEEE 802.1x standard that promotes security in a wireless environment and provides a secure connection for controlling access to the wireless power supply device 318 given that the wireless access point 340 linking the wireless power supply device 318 to the other end of the portal 330 via a wireless communications link 324 is an IEEE 802.1x standard wireless access point. In particular, the portal 330 having a secure connection, preferably, a wired connection, runs the IEEE 802.1x based power addressable protocol (PADDP) for securely communicating and transferring encrypted data from the client 312 to the power supply device 318 via the wireless access point 340 in the system 300. In a preferred embodiment, the power supply device 318 is assigned an identity (called a power-supply-identity or PADDP identity), which is used by the 802.1x based power addressable protocol running on the portal 330 to authenticate the power supply device 318 (as will be explained with respect to FIG. 4, herein below) and to communicate any messages to the power supply device and, hence, to control security on any server or computer being powered by the power supply device 318 (for instance, the servers 316 and 320, respectively). Preferably, the power-supply-identity is either the serial number of the power supply device or a pre-shared or secret key based on the unique serial number of the power supply device itself or an IEEE 802.1x certificate based on the serial number of the power supply device. For instance, if the power-supply-identity is a pre-shared key or secret key based on the unique serial number of the power supply device, the IEEE 802.1x standard based power addressable protocol running on the portal 330 performs a key exchange using the serial number or the pre-shared key or the IEEE 802.1x certificate based on the serial number of the power supply device 318 to authenticate the power supply device 318. More particularly, the power addressable protocol running on the portal 330 encrypts the power-supply-identity with an AES based encryption key, such that the key exchange is secure. Moreover, the power addressable protocol running on the portal encrypts, preferably, using AES, any directive from an authorized client 312 and communicates the directive to the power supply device 318. The power addressable protocol sends a secure communication in the form of an embedded message, namely, as IEEE 802.1x-PADDP packets that are encrypted using AES, to the power supply device, wherein the secure communication only contains directives or commands received from the authorized client, such as on, off, status query, etc. Preferably, the client 312 is also registered with the portal 330, similar to the power supply device 318 and the remote unattended network device 316. When the client registers with the portal, the client 312 is assigned a userid and password and the portal 330 stores any authorization rights given to a client with respect to any device that can be accessed on the system 300. Thus, when a client 312 tries to access the portal 330 for controlling the power supply device 318, preferably, using a front end application, more preferably, a web-based application, the portal 330 authenticates the client 312 and checks the authorization or access rights of the client with respect to the power supply device 318, before encrypting and transmitting any communications from the client 312 to the power supply device 318, thus, avoiding any unauthorized access by a client that is not authorized to access the power supply device and, hence, the remote unattended network device within the system 300. Additionally, the access point 340 through which communications are passed from the portal 330 to the wireless power supply device 318, and vice versa, is also registered with the portal 330, such that a role-group (role and/or group) is assigned to the access point 340. Preferably, when setting up the system 300, the portal 330 also authenticates the IEEE 802.1x based access point 340 using any authentication method supported by the IEEE 802.1x standard, thus, ensuring secure communications. Preferably, the portal uses the power addressable protocol to register the wireless access point. As such, the IEEE 802.1x based power addressable protocol enables the portal 330 to secure any communications being sent between the client 312 and the power supply device 318 via the wireless access point 340, since the client 312 is not allowed to communicate directly with the wireless remote network power supply device 318, but rather has to go through the centralized portal 330, thus, providing a secure connection for sending and receiving secure communications and reducing the risk of an eavesdropper gaining access to any data being transmitted.

Referring to FIG. 2, for instance, when a client or user desires to access a remote network power supply device in order to turn on the power or to turn off the power or to monitor one or more parameters affecting the power on a remote unattended network device 216 being controlled by the power supply device 218, the client 212 accesses the portal using a computer or device on the network. In particular, the client 212 accesses a front end application, preferably, a web-based application, such as the WebSphere® application that is commercially available from International Business Machines (IBM). Preferably, the Websphere® application residing on the portal uses one or more secure protocols, such as, SSH (Secure Shell). Accordingly, the user is prompted to enter client or user credentials, for instance, a username or userid and password at a login screen or prompt. Alternatively, the client 212 can access a web-based application that uses any secure protocol, such as, EAP (Extensible Authentication Protocol), LEAP (Lightweight Access Protocol), PEAP (Protective EAP), SecureID), Kerberos, Radius (Remote Authentication Dial-In User Service), LDAP (Lightweight Directory Access Protocol), SSL (Secure Sockets Layer), etc. in order to access the portal 230 to control the remote network power supply device 218. The client 212 provides the userid or username and password to the portal 230, the portal passes on the client credentials to the authentication server 250, which verifies the client credentials and sends the portal an authentication success or failure message. If the message received by the portal is an authentication success message, the portal grants access to the client 212. Once the client 212 has been authorized, the client 212 then enters or inputs a directive or command or query to the portal 230 for accessing the remote network power supply device 218. For instance, the client can turn on the power supply device, can turn off the power supply device or monitor or obtain the status of certain parameters (voltage, temperature, etc.) pertaining to the power supply device 218 and, hence, control (power up or power down) the servers 216 and 220 that are powered by the power supply device 218. For instance, if the client 212 issues a directive to turn off the remote network power supply device 218, then the portal 230 encrypts the directive using an encryption algorithm, such as, AES, and then executes the power addressable protocol for forwarding or transmitting the encrypted directive in the form of IEEE 802.1x-PADDP packets encrypted with AES to the power supply device 218.

In another embodiment, the invention provides a method of providing an information technology security service to a customer for controlling security of a remote network device powered by a remote network power device. The method comprises embedding a secure standard in a wireless power supply device powering a remote unattended network device. Preferably, the secure standard is contained on a chip that is embedded within the power supply device. The method includes providing a portal having a secure connection for controlling the wireless power supply device. Further, the method comprises implementing the secure standard in a wireless access point that links the wireless power supply device to the portal. The method further includes registering the wireless power supply device, the remote unattended network device and the wireless access point with the portal, authenticating via the portal the wireless power supply device and the wireless access point, and executing on the portal a power addressable protocol based on the secure standard for communicating one or more secure communications over the secure connection in response to a directive issued by an authorized client for controlling the wireless power supply device powering the remote unattended network device. The authenticating step further comprises the portal using a power-supply-identity of the wireless power supply device for authenticating the wireless power supply device and, in particular, using an encryption algorithm to encrypt the power-supply-identity for authenticating the wireless power supply device and the power addressable protocol for sending and receiving data packets containing the power-supply-identity. Similarly, the portal authenticates the wireless access point using an identity that is assigned to the wireless access point during registration. Preferably, the method includes keeping a log of all clients who request access to the system, as well as the result or outcome of the access transaction. Further, the executing step further comprises using an encryption algorithm to encrypt the directive issued by the authorized client and transmitting the encrypted directive to the wireless power supply device. Furthermore, the registering step comprises assigning a role-group to each of the remote unattended network device, the wireless power supply device and the client such that the portal is able to validate or confirm the authentication and authorization of the client in relation to the role-group (role and/or group) assigned to the power supply device and the role-group assigned to the remote unattended network device before allowing any client or user access to control the wireless power supply device powering the remote unattended network device. Preferably, the secure standard is an IEEE 802.1x standard and the power addressable protocol is based on the IEEE 802.1x standard.

In one embodiment, as shown in FIG. 3, the method comprises providing a portal that is configured to carryout all necessary steps for authenticating each of the wireless power supply device, the remote unattended network device, the wireless access point and the client. In an alternative embodiment, as shown in FIGS. 1 and 2, the method comprises providing an authentication server employing the secure standard, namely, the IEEE 802.1x standard, that is securely linked or connected to the portal and is configured to store or access authentication data or information for validating a client and/or device in the system. In particular, the method includes conveying the power-supply-identity and/or the client credentials from the portal to the authentication server, using the power addressable protocol, such that the information is passed securely to the authentication server, and the authentication server is able to validate the power-supply-identity of the power supply device and/or the client-identity of the client. Preferably, the network on which the one or more remote unattended network devices powered by the power supply device reside is either a wired network or a wireless network. More preferably, if a wireless network, the wireless network is a wireless LAN (Local Area Network) and, if a wired network, preferably, the wired network is either an Ethernet based LAN or a Token-Ring LAN. Moreover, the network on which the remote unattended network devices reside can also be a wired or wireless WAN (Wide Area Network).

Turning to FIG. 4, FIG. 4 illustrates the steps by which a portal authenticates a power supply device, preferably, a wireless power supply device. FIG. 4, shows a system 400 where the wireless access point 440 is connected to the portal 430 on one end via a wired communications line 432 and is connected to the power supply device 418 via a wireless communications link 420. Preferably, the power supply device has embedded thereon the IEEE 802.1x standard, for instance, on a chip, and the wireless access point 440 is an IEEE 802.1x enabled wireless access point 440. When the system is set up, the wireless access point 440 and the power supply device 418 are each registered with the portal 430, as explained herein above. Furthermore, the system is set up such that both the wireless access point 440 and the power supply device 418 are authenticated in advance by the portal 430. Preferably, the power supply device 418 is authenticated by the portal 430 by running the power addressable protocol on the portal 430, which performs an AES based encryption key exchange. For instance, if a pre-shared key is the power-supply-identity, the power addressable protocol performs an AES based encryption key exchange using the serial number of the power supply device 418 as the pre-shared key. In particular, as shown in FIG. 4, the portal 430 issues a PADDP Identity Request in step 401 to the power supply device 418, the power supply device 418 receives the PADDP Identity Request in step 402 and sends a PADDP Identity Response in step 404 to the portal 430. Preferably, the PADDP Identity Response is either the serial number of the power supply device or a secret or pre-shared key based on the serial number of the device or alternatively an IEEE 802.1x certificate based on the serial number of the device. The portal 430 receives the PADDP Identity Response from the power supply device 418 in step 403. As explained previously, the portal 430 can either handle all of the authentication itself (as shown in the embodiment of FIG. 3) or the portal 430 can transmit or pass the authentication information received from the power supply device 418 to an authentication server (as shown in the embodiments of FIGS. 1 and 2) for verification (not shown in FIG. 4). If the PADDP Identity Response is verified by the portal 430 (either directly by the portal 430 itself or indirectly via an authentication server), the portal 430 then issues a PADDP Authorization Request in step 405 to the power supply device 418. The power supply device 418 receives the PADDP Authorization Request in step 406 and replies with a PADDP Authorization Response in step 408, which is received by the portal 430 in step 407. Preferably, the PADDP Authorization Response is associated with the role-group (role and/or group) assigned to the power supply device 418 during the registration process at setup. Again, the portal 430 verifies the response directly or uses an authentication server, preferably, based on the IEEE 802.1x standard, for verification purposes. If an authentication server is used, the authentication server sends the portal 430 a success or failure message. If the authentication is a success, the portal 430 sends a PADDP Success message to the power supply device 418. Further, preferably, the wireless access point 440 is authenticated by the portal 430 using an authentication protocol and method that is supported by the IEEE 802.1x standard.

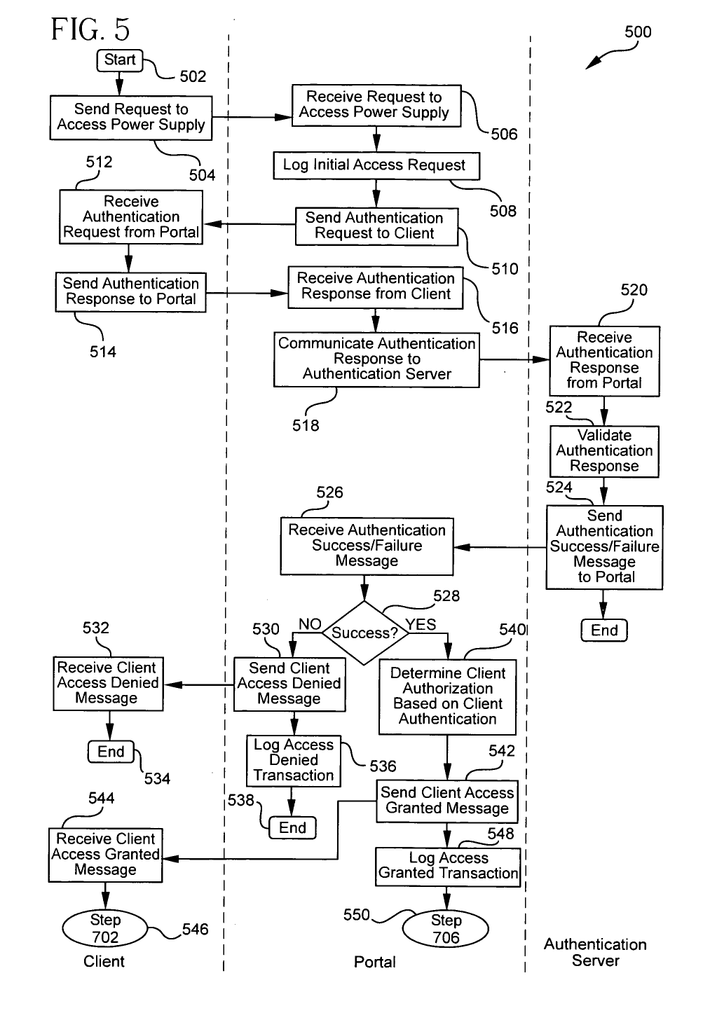

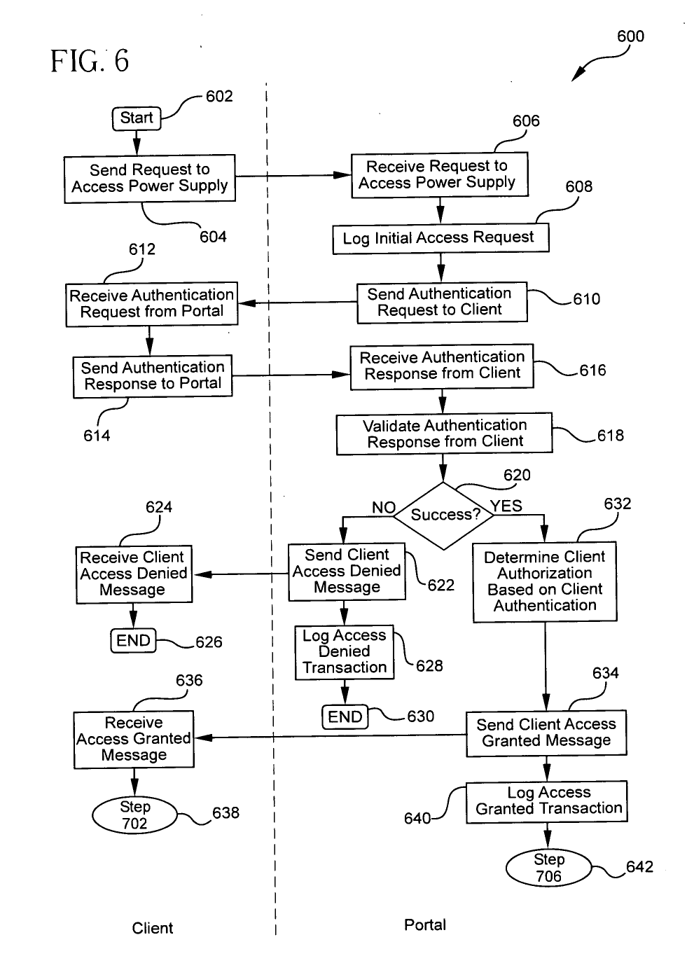

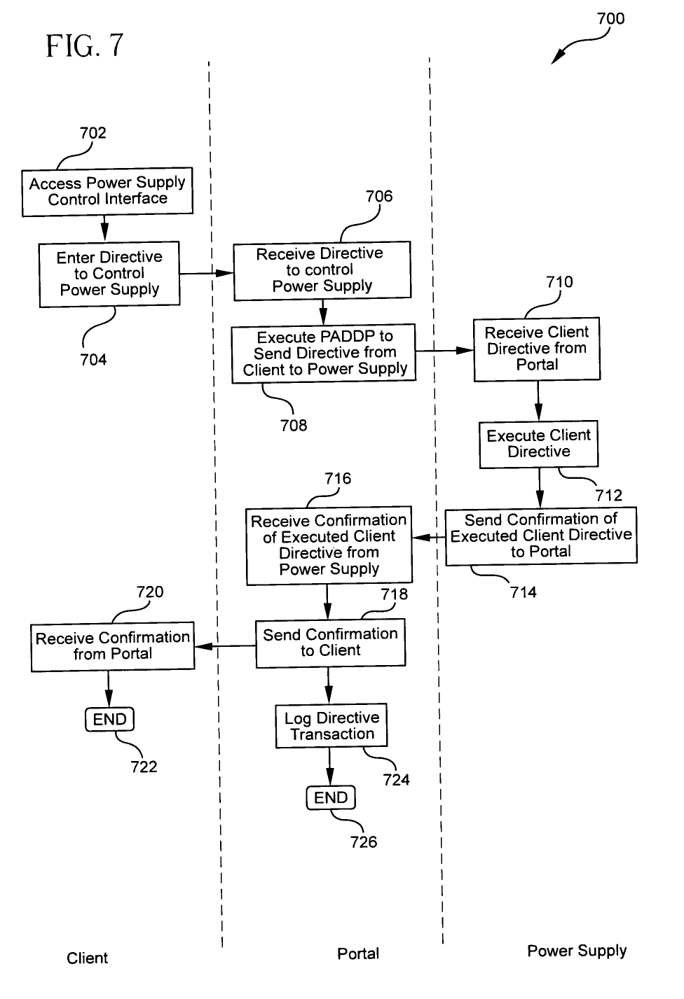

Reference is now made to FIGS. 5-7, which illustrate a method of controlling security of a remote network power device powering a remote unattended network device. In particular, FIGS. 5 and 7 outline the steps involved in controlling security of a remote network power device, where the system includes an authentication server, as shown in FIGS. 1 and 2. Further, FIGS. 6 and 7 outline the steps involved in controlling security of a remote network power device, where the system does not include an authentication server, as shown in FIG. 3. Turning to FIG. 5, as shown in FIG. 5, the client requests access to the remote network power supply device by sending an access request to the portal in step 504 via a front end application, preferably a web-based application, which is received by the portal in step 506. Preferably, the portal keeps a log of the initial access request in step 508 and sends an authentication request to the client in step 510. The client receives the authentication request from the portal in step 512 and sends an authentication response to the portal in step 514. The portal receives the authentication response from the client in 516 and forwards the authentication response to the authentication server in step 520. The authentication server validates the authentication response in step 522 and sends an authentication success/failure message to the portal in step 524, which ends the role of the authentication server. The portal receives the authentication success/failure message in step 526. If the authentication was a failure in step 528, the portal sends the client an access denied message in step 530, which is received by the client in step 532, and the session is terminated or comes to an end. Further, the portal logs data pertaining to the access denied transaction in step 536. If the authentication was a success in step 528, the portal determines the client authorization based on the client authentication in step 540. Depending on the role-group assigned to the client in relation to the power supply device and what the client is allowed to do, the portal sends the client an access granted message in step 542, which message is received by the client in step 544. The portal logs data pertaining to the access granted transaction in step 548.

Alternatively, as shown in FIG. 6, the client requests access to the power supply device by sending a request to the portal in step 604, which is received by the portal in step 606. Preferably, the portal keeps a log of the initial access request in step 608 and sends an authentication request to the client in step 610. The client receives the authentication request from the portal in step 612 and sends the authentication response to the portal in step 614. The portal receives the authentication response from the client in 616 and the portal validates the authentication response in step 618. If the portal determines that the client authentication was a failure in step 620, the portal sends the client an access denied message in step 622, which is received by the client in step 624, and the session is terminated or comes to an end. Further, the portal logs data pertaining to the access denied transaction in step 628. If the authentication was a success in step 620, the portal determines the client authorization based on the client authentication in step 632. Depending on the role-group assigned to the client in relation to the power supply device and what the client is allowed to do, the portal sends the client an access granted message in step 634, which message is received by the client in step 636. The portal logs data pertaining to the access granted transaction in step 640.

In either embodiment, once the client has been granted access, that is, the client has been deemed to be an authorized client, the client can access a web interface for controlling the remote network power supply device, as shown in step 702 of FIG. 7. The client enters a directive to control the power supply device in step 704, the portal receives the directive from the client in step 706 and encrypts the directive, preferably, using the AES encryption to encrypt the directive and executes the power addressable protocol to send or transmit the directive to the power supply device in 708. The power supply device receives the client directive from the portal in step 710 and executes the client directive in step 712. The power supply device sends a confirmation of the executed client directive to the portal in step 714, which is received by the portal in step 716. The portal sends the confirmation to the client in step 718, which confirmation is received by the client in step 720. The client then ends the session. Further, the portal logs data pertaining to the client directive transaction in step 724, before ending the session.

Further yet, in another embodiment, the invention comprises a computer system having software installed thereon that is specific to controlling security of a remote network power device that powers a remote unattended network device. In particular, the computer system comprises a computer server or an equivalent device, a computer readable storage media or more preferably, a programmable media containing programmable software in a form that is executable by a computer system to control security of a remote power supply device that powers a remote unattended network device. The programmable software comprises registering the remote unattended network device and the remote network power supply device with a portal having a secure connection, authenticating the power supply device using a power-supply-identity of the power supply device based on a secure standard embedded in the power supply device, and executing a power addressable protocol on the portal for transmitting one or more secure communications over the secure connection in response to a directive issued by an authorized client for controlling the power supply device powering the remote unattended network device. In one embodiment, the programmable software further comprises validating the power-supply-identity via an authentication server based on the secure standard and securely linked to the portal. Preferably, the secure standard is an IEEE 802.1x standard and the power addressable protocol is based on the IEEE 802.1x standard. More preferably, the IEEE 802.1x standard is embedded within the power supply device, preferably, on a chip. Further, the power-supply-identity preferably comprises either a unique serial number of the power supply device or a secret or pre-shared key based on a unique serial number of the power supply device or an IEEE 802.1x certificate based on the unique serial number of the power supply device. More preferably, the power addressable protocol uses the power-supply-identity of the power supply device to authenticate the power supply device. In particular, the power addressable protocol uses an encryption algorithm, such as AES to encrypt the power-supply-identity when exchanging keys during authentication. Further, the power addressable protocol uses an encryption algorithm, such as AES to encrypt the directive issued by the authorized client and uses the power addressable protocol to transmit the encrypted directive to the power supply device in the form of an embedded message, that is, IEEE 802.1x-PADDP packets encrypted with AES. Preferably, the portal keeps a record/log of all access requests/transactions including the result/outcome of any access requests. In one embodiment, the power supply device is a wireless power supply device and further comprises a wireless access point having the secure standard implemented thereon and securely linked to the portal for connecting the wireless power supply device to the portal. Preferably, the client or user uses a computer terminal or an equivalent device for accessing a front end application, more preferably, a web-based application on the portal.

The foregoing descriptions of specific embodiments of the present invention have been presented for the purpose of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

We claim:

1. A system for controlling security of a remote network power supply device, comprising:
a remote network power supply device having a secure standard implemented thereon and having a power-supply-identity;
a remote unattended network device powered from said remote network power supply device;
a portal having a secure connection for controlling said remote network power supply device; and
a power addressable protocol based on said secure standard and running on said portal for receiving and sending one or more secure communications over said secure connection in response to a directive issued by an authorized client for controlling said remote network power supply device powering said remote unattended network device.

2. The system according to claim 1, further comprising:
an authentication server employing said secure standard and securely linked to said portal for validating said remote network power supply device.

3. The system according to claim 1, wherein said secure standard is an IEEE 802.1x standard; and wherein said power addressable protocol is based on said IEEE 802.1x standard.

4. The system according to claim 3, wherein said portal uses said power-supply-identity of said remote network power supply device to authenticate said remote network power supply device.

5. The system according to claim 4, wherein said power-supply-identity comprises at least one of: a unique serial number of said remote network power supply device, a secret key based on a unique serial number of said remote network power supply device, and an IEEE 802.1x certificate based on a unique serial number of said remote network power supply device.

6. The system according to claim 5, wherein said portal uses an encryption algorithm based on said secure standard to encrypt said power-supply-identity for authenticating said remote network power supply device; and wherein said power addressable protocol uses an encryption algorithm based on said secure standard to encrypt said directive issued by said authorized client for transmitting said encrypted directive to said remote network power supply device.

7. The system according to claim 5, wherein said portal authenticates said authorized client using an authentication method supported by said IEEE 802.1x standard.

8. The system according to claim 5, wherein said remote unattended network device and said remote network power supply device are each registered with said portal, and wherein said portal logs each request to access said system and wherein said portal logs any result of said request.

9. The system according to claim 5, wherein said remote network power supply device is a wireless remote network power supply device and wherein said system further comprises:
a wireless access point having said secure standard implemented thereon and linked to said portal for securely connecting said wireless remote network power supply device to said portal.

10. A method of providing an information security service to a customer, said method comprising the steps of:
embedding a secure standard in a wireless power supply device powering a remote unattended network device;
providing a portal having a secure connection for controlling said wireless power supply device;
implementing said secure standard in a wireless access point that links said wireless power supply device to said portal;
registering with said portal said wireless power supply device, said remote unattended network device and said wireless access point;
authenticating via said portal said wireless power supply device and said wireless access point; and
executing on said portal a power addressable protocol based on said secure standard for communicating one or more secure communications over said secure connection in response to a directive issued by an authorized client for controlling said wireless power supply device powering said remote unattended network device.

11. A method according to claim 10, further comprising the step of:
keeping a log of all clients that request access to said portal; and wherein said secure standard is an IEEE 802.1x standard and wherein said power addressable protocol is based on said IEEE 802.1x standard.

12. A method according to claim 11, wherein said registering step further comprises the step of:
assigning a role-group to each of said remote unattended network device, said wireless power supply device, and said client such that said portal is able to validate authentication and authorization of said client in relation to said wireless power supply device and said remote unattended network device before allowing any access to control said wireless power supply device powering said remote unattended network device.

13. A method according to claim 11, wherein said authenticating step further comprises the steps of:
using a power-supply-identity of said wireless power supply device for authenticating said wireless power supply device; and
using an encryption algorithm based on said secure standard to encrypt said power-supply-identity for authenticating said wireless power supply device.

14. A method according to claim 11, wherein said executing step further comprises the step of:
using an encryption algorithm to encrypt said directive issued by said authorized client and transmitting said encrypted directive to said wireless power supply device.

15. Programmable media containing programmable software for controlling security of a remote network power device powering a remote unattended network device, said programmable software comprising the steps of:
registering said remote unattended network device and said remote network power supply device with a portal having a secure connection;
authenticating said power supply device using a power-supply-identity of said power supply device having a secure standard embedded thereon; and
executing a power addressable protocol on said portal for transmitting one or more secure communications over said secure connection in response to a directive issued by an authorized client for controlling said power supply device powering said remote unattended network device.

16. The programmable media according to claim 15, wherein said programmable software further comprises the step of:
validating said power-supply-identity via an authentication server having said secure standard and securely linked to said portal; and
keeping a log of all clients that request access to said portal.

17. The programmable media according to claim 15, wherein said secure standard is an IEEE 802.1x standard and wherein said power addressable protocol is based on said IEEE 802.1x standard.

18. The programmable media according to claim 15, wherein said power-supply-identity comprises at least one of: a unique serial number of said power supply device, a secret key based on a unique serial number of said power supply device, and an IEEE 802.1x certificate based on a unique serial number of said power supply device.

19. The programmable media according to claim 15, wherein said power addressable protocol uses an encryption algorithm based on said secure standard to encrypt said power-supply-identity of said power supply device to authenticate said power supply device; and wherein said power addressable protocol uses an encryption algorithm to encrypt said directive issued by said authorized client and transmits said encrypted directive to said power supply device.

20. The programmable media according to claim 19, wherein said power supply device is a wireless power supply device and wherein said programmable software further comprises:
a wireless access point having said secure standard implemented thereon and linked to said portal for securely connecting said wireless power supply device to said portal.
